(19) United States
(12) Patent Application Publication
(10) Pub. No.: US 2018/0007077 A1
(43) Pub. Date: Jan. 4, 2018

(54) SCALABLE COMPUTER VULNERABILITY TESTING

(71) Applicant: Microsoft Technology Licensing, LLC, Redmond, WA (US)

(72) Inventors: Dragos Boia, Seattle, WA (US); Alisson Sol, Bellevue, WA (US); Jiong Qiu, Sammamish, WA (US); Erik Tayler, Seattle, WA (US); Johnathan Irwin, Seattle, WA (US); Leena Sheth, Bothell, WA (US)

(73) Assignee: Microsoft Technology Licensing, LLC, Redmond, WA (US)

(21) Appl. No.: 15/197,192

(22) Filed: Jun. 29, 2016

(51) Int. Cl. H04L 29/06; G06F 9/48; G06F 9/455; G06F 17/30; G06F 21/53

(52) U.S. Cl. CPC H04L 63/1433; G06F 17/30867; G06F 21/53; G06F 9/45508; G06F 9/4881; G06F 2221/034

(57) ABSTRACT

Vulnerability testing tasks can be received and distributed, via a work scheduler, to computer test environments. Each of the test environments can have a detector computing component running in the environment. Each detector component can respond to receiving one of the tasks from the work scheduler by conducting a vulnerability test on an endpoint of a target, detecting results of the vulnerability test, generating output indicating the results of the vulnerability test, and sending the output to an output processor. The work scheduler can initiate dynamic scaling of the test environments by activating and deactivating test environments in response to determining that the test environments are overloaded or underloaded, respectively. Also an overall time-based limit on testing for a target can be enforced via the work scheduler.

### BACKGROUND

Both applications and online services have an attack surface, which includes available endpoints, such as APIs (application programming interfaces), web request endpoints (such as uniform resource locators), configuration files, and the user interface. Some existing solutions, if given a target such as an online service or application, will perform a few tests using available endpoints to detect a vulnerability to threats and attacks. For example, some previous application security scanning has relied on execution of manual or semi-automated tests according to lists of tests that are required for application certification and listing on online stores. Additionally, penetration testing has been performed by “white hat” experts. Those experts, often hired on a permanent or contract basis, try to act as hackers attacking the target. When finding a vulnerability, instead of exploiting it, they would disclose it to the development and operations teams, allowing it to be properly remediated. Some companies providing services also have in place bug bounty programs, which reward users for disclosing vulnerabilities in the companies' applications and/or online services.

### SUMMARY

The tools and techniques discussed herein relate to technical solutions for addressing current problems with vulnerability testing of computer components, such as the lack of an ability to effectively scale vulnerability testing tools and techniques to effectively facilitate multiple vulnerability tests and/or multiple target endpoints

In one aspect, the tools and techniques can include receiving, via a work scheduler, a plurality of computer-readable vulnerability testing tasks identifying a plurality of targets to be tested and a plurality of tests to be run on computerized targets specified in the tasks. Each of the tasks can identify an endpoint of a target and a test to be run on the target, and the work scheduler can be a computer component running on computer hardware, such as hardware including memory and a processor. Each of the targets can also be a computer component running on computer hardware, such as hardware including memory and a processor. The technique can also include distributing, via the work scheduler, the tasks to a plurality of test environments running on computer hardware. Each of the test environments can have a detector computing component running in the environment. Each detector component can respond to receiving one of the tasks from the work scheduler. The response of the detector can include conducting a vulnerability test on an endpoint of a target, with the endpoint and the test being specified by the task. The response can also include detecting results of the vulnerability test, with the results indicating whether behavior of the target in response to the test indicates presence of a vulnerability corresponding to the vulnerability test. The response can also include generating output indicating the results of the vulnerability test, and may also include sending the output to an output processor.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described aspects may be implemented.

FIG. 2 is a schematic diagram illustrating computer components of a vulnerability testing system.

FIG. 3 is a block diagram illustrating computer components of a computerized vulnerability testing service.

FIG. 4 is a flowchart of a scalable computer vulnerability testing technique.

FIG. 5 is a flowchart of dynamic scaling for a scalable computer vulnerability testing technique.

### DETAILED DESCRIPTION

Aspects described herein are directed to techniques and tools for improved computer vulnerability testing. Such improvements may result from the use of various techniques and tools separately or in combination.

Such techniques and tools may include a testing computer system that addresses the need of scaling up to test multiple endpoints of applications and/or online sites for vulnerabilities. The sites may include large online sites, such as some sites with the top traffic and largest attack surfaces on the Internet. The system may also identify vulnerabilities in applications, such as connected applications that make use of online services for their functionality. As used herein, a vulnerability is a feature of a computer component (a target) that allows the target to be exploited by malicious computer resources (computer code, computer machines, etc.) to produce behavior that is outside the bounds of the behavior the target is designed to exhibit. For example, a vulnerability of an online service or an application (the target) may allow a malicious user to invoke computer resources to gain access to personal information that would be expected to be protected. As another example, a vulnerability may allow a user or automated resource (the attacker) to manipulate the target to exhibit behavior that would reflect poorly on the developers of the target, such as where the attacker manipulates the target to use derogatory language when interacting with user profiles. For example, such a vulnerability could be exhibited by bots such as messaging bots and/or with more standard applications and/or online services. Vulnerability testing refers to testing to discover such vulnerabilities, so that the vulnerabilities can be eliminated or at least the impact of the vulnerabilities can be understood and reduced. An example of such vulnerability testing is penetration testing, where a tester attempts to conduct at least some portion of an attack to determine whether the target exhibits behavior indicating the target is susceptible to that attack. Other vulnerability testing may be more passive, such as testing that examines characteristics of data being sent to and/or from the target, or data being stored by the target. For example, the testing may reveal that data is being sent and/or stored in a non-encrypted format in a manner that could allow an attacker to gain access to sensitive information being managed by the target. Vulnerability testing and/or vulnerabilities themselves may take other forms as well.

The computer system can be a dynamically scalable system that benefits from a modular architecture that allows dynamic scalability to multiple endpoints, such as millions of endpoints that can be receiving hundreds of tests. The system can scale dynamically to elastically benefit from many testing environments, such as hundreds of computing machines (such as virtual machines and/or physical machines). The system can spawn several target environments to be tested, from multiple browsers to multiple desktop or mobile platforms. In doing this, the system can make use of online computer resources and may use virtualization.

The testing system can use a configurable attack pipeline to feed testing worker computing components, such as for continuous execution of tests against online services and/or applications. The system can activate a virtual environment, such as a virtual machine, which can be configured to run a target environment being tested, and/or to run a computer component that is configured to interact with a target environment being tested. The testing system can be scalable to accept multiple attack pipelines (sets of endpoints to be tested), multiple target environments, and/or make use of resources in multiple testing environments. Certain testing environments may have an affinity for certain types of tests recorded in the system, which can affect which environments are assigned to conduct which tests.

The system can also have a built-in configurable per-target (such as per-domain) throttling control to avoid adversely impacting performance of online live sites that are utilized in tests. The system can also have an interface (such as an application programming interface (API)) to allow input to be provided to create, cancel, and get status and results of “scans” (sets that each include one or more tests for one or more defined endpoints of one or more targets).

Accordingly, one or more substantial benefits can be realized from the vulnerability testing tools and techniques described herein. For example, the testing system can include modular components that can work together to provide an efficient and scalable system that is able to be scaled to test multiple endpoints of online sites and/or local applications. For example, such a system may include the input pipelines that feed the system with data from which particular testing tasks are generated in the system. The system can also include a work scheduler that can manage multiple different testing environments, such as virtual machines, and can distribute the testing tasks to those machines in an efficient and scalable manner. The system can also include computer components that can be termed detectors, which can conduct tests in the testing environments and detect results of those tests, as well as provide indications of such results to an output processor. Such a modular system can allow for efficient testing, it can allow for scalability (such as dynamic scalability of testing environments, which may be automated), and it can allow for effective testing of a variety of targets and endpoints. Accordingly, the tools and techniques discussed herein, whether used together or separately, can improve the functioning of the testing computer system. Moreover, it can reveal vulnerabilities in the computerized targets of the tests, which can lead to changes to address such vulnerabilities. Accordingly, the tools and techniques discussed herein can also improve the computerized targets being tested.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

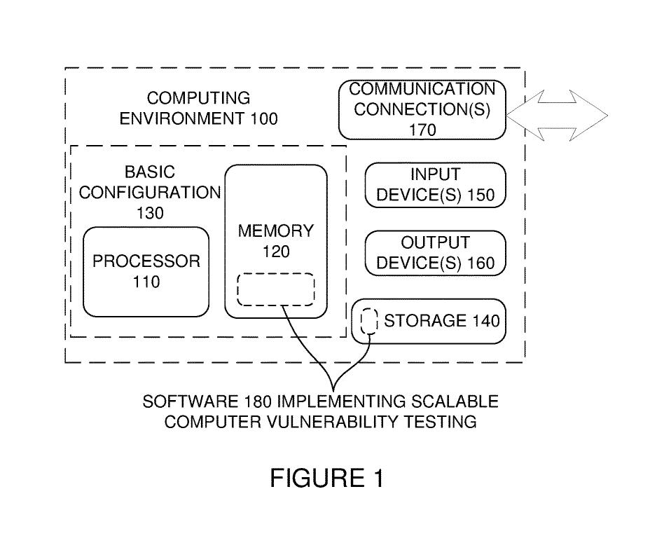

Techniques described herein may be used with one or more of the systems described herein and/or with one or more other systems. For example, the various procedures described herein may be implemented with hardware or software, or a combination of both. For example, the processor, memory, storage, output device(s), input device(s), and/or communication connections discussed below with reference to FIG. 1 can each be at least a portion of one or more hardware components. Dedicated hardware logic components can be constructed to implement at least a portion of one or more of the techniques described herein. For example and without limitation, such hardware logic components may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Applications that may include the apparatus and systems of various aspects can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

### I. Exemplary Computing Environment

FIG. 1 illustrates a generalized example of a suitable computing environment 100 in which one or more of the described aspects may be implemented. For example, one or more such computing environments can be used to host one or more components discussed below, such as a host machine for a testing environment and/or a target, a client machine, a machine collecting data for an attack pipeline, a machine hosting a work scheduler, a machine hosting an output processor, etc. Generally, various different computing system configurations can be used. Examples of well-known computing system configurations that may be suitable for use with the tools and techniques described herein include, but are not limited to, server farms and server clusters, personal computers, server computers, smart phones, laptop devices, slate devices, game consoles, multiprocessor systems, microprocessor-based systems, programmable consumer electronics, network PCs, minicomputers, mainframe computers, distributed computing environments that include any of the above systems or devices, and the like.

The computing environment 100 is not intended to suggest any limitation as to scope of use or functionality of the invention, as the present invention may be implemented in diverse types of computing environments.

With reference to FIG. 1, various illustrated hardware-based computer components will be discussed. As will be discussed, these hardware components may store and/or execute software. The computing environment 100 includes at least one processing unit or processor 110 and memory 120. In FIG. 1, this most basic configuration 130 is included within a dashed line. The processing unit 110 executes computer-executable instructions and may be a real or a virtual processor. In a multi-processing system, multiple processing units execute computer-executable instructions to increase processing power. The memory 120 may be volatile memory (e.g., registers, cache, RAM), non-volatile memory (e.g., ROM, EEPROM, flash memory), or some combination of the two. The memory 120 stores software 180 implementing scalable computer vulnerability testing. An implementation of scalable computer vulnerability testing may involve all or part of the activities of the processor 110 and memory 120 being embodied in hardware logic as an alternative to or in addition to the software 180.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component (e.g., if the display device includes a touch screen). Also, processors have memory. The inventors hereof recognize that such is the nature of the art and reiterate that the diagram of FIG. 1 is merely illustrative of an exemplary computing device that can be used in connection with one or more aspects of the technology discussed herein. Distinction is not made between such categories as “workstation,” “server,” “laptop,” “handheld device,” etc., as all are contemplated within the scope of FIG. 1 and reference to “computer,” “computing environment,” or “computing device.”

A computing environment 100 may have additional features. In FIG. 1, the computing environment 100 includes storage 140, one or more input devices 150, one or more output devices 160, and one or more communication connections 170. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100.

The memory 120 can include storage 140 (though they are depicted separately in FIG. 1 for convenience), which may be removable or non-removable, and may include computer-readable storage media such as flash drives, magnetic disks, magnetic tapes or cassettes, CD-ROMs, CD-RWs, DVDs, which can be used to store information and which can be accessed within the computing environment 100. The storage 140 stores instructions for the software 180.

The input device(s) 150 may be one or more of various different input devices. For example, the input device(s) 150 may include a user device such as a mouse, keyboard, trackball, etc. The input device(s) 150 may implement one or more natural user interface techniques, such as speech recognition, touch and stylus recognition, recognition of gestures in contact with the input device(s) 150 and adjacent to the input device(s) 150, recognition of air gestures, head and eye tracking, voice and speech recognition, sensing user brain activity (e.g., using EEG and related methods), and machine intelligence (e.g., using machine intelligence to understand user intentions and goals). As other examples, the input device(s) 150 may include a scanning device; a network adapter; a CD/DVD reader; or another device that provides input to the computing environment 100. The output device(s) 160 may be a display, printer, speaker, CD/DVD-writer, network adapter, or another device that provides output from the computing environment 100. The input device(s) 150 and output device(s) 160 may be incorporated in a single system or device, such as a touch screen or a virtual reality system.

The communication connection(s) 170 enable communication over a communication medium to another computing entity. Additionally, functionality of the components of the computing environment 100 may be implemented in a single computing machine or in multiple computing machines that are able to communicate over communication connections. Thus, the computing environment 100 may operate in a networked environment using logical connections to one or more remote computing devices, such as a handheld computing device, a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment 100, computer-readable storage media include memory 120, storage 140, and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various aspects. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. Scalable Computer Vulnerability Testing System

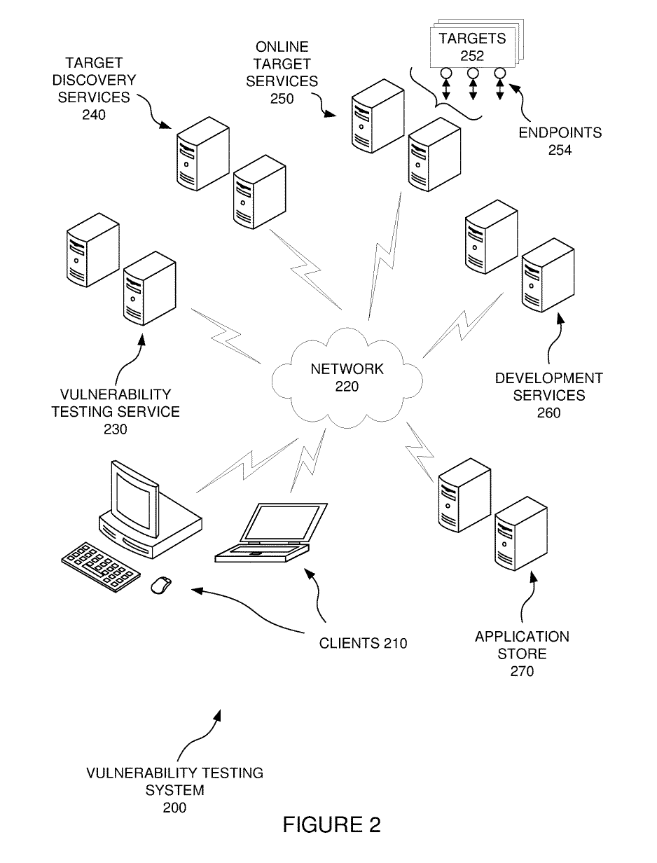

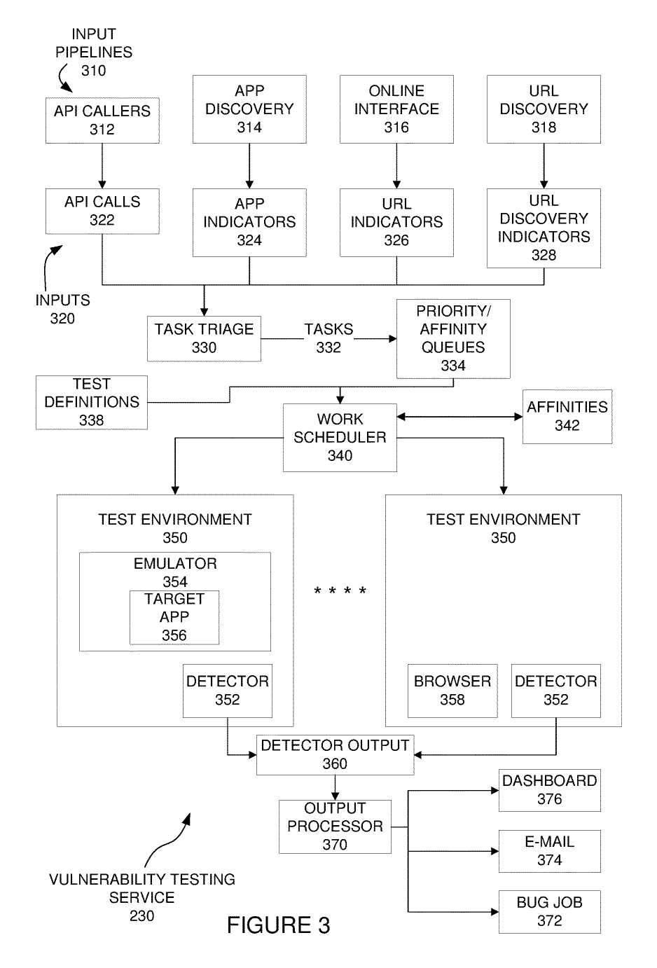

FIG. 2 is a schematic diagram of a scalable computer vulnerability testing system 200 in conjunction with which one or more of the described aspects may be implemented. Communications between the various devices and components discussed herein, such as with reference to FIG. 2 and/or FIG. 3, can be sent using computer system hardware, such as hardware within a single computing device, hardware in multiple computing devices, and/or computer network hardware. A communication or data item may be considered to be sent to a destination by a component if that component passes the communication or data item to the system in a manner that directs the system to route the item or communication to the destination, such as by including an appropriate identifier or address associated with the destination. Also, a data item may be sent in multiple ways, such as by directly sending the item or by sending a notification that includes an address or pointer for use by the receiver to access the data item. In addition, multiple requests may be sent by sending a single request that requests performance of multiple tasks.

A. Components of the Scalable Computer Vulnerability Testing System

Referring now to FIG. 2, components of the scalable computer vulnerability testing system 200 will be discussed. Each of the components includes hardware, and may also include software. For example, a component of FIG. 2 and/or FIG. 3 can be implemented entirely in computer hardware, such as in a system on a chip configuration. Alternatively, a component can be implemented in computer hardware that is configured according to computer software and running the computer software. The components can be distributed across computing machines or grouped into a single computing machine in various different ways. For example, a single component may be distributed across multiple different computing machines (e.g., with some of the operations of the component being performed on one or more client computing devices and other operations of the component being performed on one or more machines of a server).

The vulnerability testing system 200 can include one or more computing clients 210. The clients can communicate with other components of the vulnerability testing system 200 via a computer network 220, which may include multiple interconnected networks, and may even be a peer-to-peer connection between multiple computing machines. The clients 210 can communicate with a vulnerability testing service 230, to provide instructions to the testing service 230 regarding tests to be performed and to receive output from tests that have been conducted via the testing service 230. An example implementation of the testing service 230 will be discussed in more detail below with reference to FIG. 3. The testing service 230 can receive inputs indicating targets to be tested from one or more target discovery services 240. As an example, the target discovery services 240 can query online target services 250 that host the targets 252 to be tested, and the target discovery services 240 can also discover endpoints 254 of those services. For example, a target 252 may be a Website that is represented by a domain (e.g., testtarget.com), and that target 252 may include multiple endpoints 254, such as specific uniform resource locators for that domain (e.g., www.testtarget.com, www.testtarget.com/endpoint1, www.testtarget.com/endpoint2). The targets and endpoints may be any of various different types of online resources. For example, an online target may be an online service that includes some specific Web pages with corresponding uniform resource locators that can act as endpoints for that target, and the target may also expose one or more application programming interfaces, which can also act as endpoints for that target.

As will be discussed below, other examples of targets include applications that can be run on clients 210, which may or may not interact with online services. For applications that interact with online services, the application itself may be a testing target, and the corresponding online service may also be a testing target, because the application and/or the online service may include vulnerabilities that can be exploited by malicious users and/or computer resources. In a specific example, applications and/or online services may include bots, such as messaging bots. As used herein, bots are computer components that can receive natural language instructions, process such instructions, and also respond with natural language scripts. The natural language instructions and/or natural language scripts may be any of various forms, such as textual data, audio files, video files, etc. The bots may also accept other input and may provide other output, such as binary code that represents data (e.g., temperature data for a weather-related bot, etc.). Such bots may be accessed through locally-run applications that are specific to the bots, and/or through online services. In some instances, the bots may be accessed from online services using Web browsers or other similar computer components.

Referring still to FIG. 2, the vulnerability testing system 200 can also include development services 260. For example, such development services may be services that provide resources for developing designs for computer components, which may include designs for software and/or hardware. The development services 260 may provide information to the testing service 230, such as for requesting testing of a target that is under development using the development services 260. The development services 260 can also receive data from the testing service 230. For example, the testing service 230 can provide testing output to the development services 260, such as in the form of data represented in a dashboard format, or in the form of automatically setting a bug job in the development services 260 (indicating the presence of a bug and setting a task for the bug to be remedied).

The testing system 200 can also include an application store 270, which can make applications available for downloading, such as to the clients 210. The application store 270 may include applications that can be targets of vulnerability tests conducted by the testing service 230. The target discovery services 240 may periodically query the application store 270 for new or updated applications that meet specified criteria, so that the target discovery services 240 can provide input to the testing service 230 requesting that the testing service conduct tests of the discovered applications.

B. Vulnerability Testing Service Example

Referring now to FIG. 3, the testing service 230 and input pipelines 310, such as input pipelines 310 that include input from the target discovery services 240, will be discussed. The input pipelines 310 refer to different channels for providing input to the testing service 230. For example, the input pipelines 310 can include API callers 312, an application discover component 314, an online interface 316, and a URL (uniform resource locator) discovery component 318. The input pipelines 310 can send inputs 320 to the testing service 230, such as the types of inputs 320 discussed below.

The API callers 312 can provide API calls 322 through an API exposed by the testing service 230. For example, an API call 322 may send an application itself or data identifying the application (such as by sending the data for the application itself, or a URL, application name, or other identifying information to assist in downloading the application from an application store or other source), and a request to perform a specified test on the application (which may include multiple sub-tests, such as where a test of an application includes testing the application for multiple different vulnerabilities). As another example, an API call 322 may include a URL for an endpoint 254 of an online target 252, such as a URL for a Web page in a Website.

The application discovery component 314 can discover applications in online sites, such as an application store 270. The application discover component 314 can return application indicators 324, which can indicate discovered application(s) to be tested, and may include information to facilitate testing, such as an address or other information to assist in downloading the application. The application discovery component 314 may also provide the installation data for each application. As an example, the application discovery component 314 can submit queries to application stores 270 to discover applications that meet specified criteria. For example, the testing system 200 may be configured to test all applications published by a specified publishing entity. The application discovery component 314 can submit queries to application stores 270, requesting a list of all applications listing the specified publishing entity as the publisher for the application. The application store 270 can respond by conducting a search of its metadata and returning a list of applications whose metadata lists the specified publishing entity as the publisher for the application. Other types of queries may also be conducted, such as all applications published by a specified publishing entity with one or more specified keywords in the application title field of the metadata in the application store 270.

The online interface 316 can allow user input to be provided to specify targets and/or target endpoints to be tested. For example, the online interface 316 may provide a Web page that includes data entry areas for entering indicators of endpoints to be tested. As an example, such a Web page may allow user input to provide URL indicators 326, which can be forwarded to the testing service 230. The online interface 316 may include interfaces to upload installation data for such applications to be provided to the testing service 230.

The URL discovery component 318 can discover URL's for online endpoints 254 to be tested. For example, the URL discovery component 318 may include a Web crawling service, which can crawl specified sites of targets 252 to be tested, returning lists of the endpoints 254 for such sites (such as URLs of Web pages for Websites to be tested). In one implementation, the URL discovery component 318 may subscribe to a general Web crawling service, such as a service that regularly indexes Web pages. Such a subscription may list sites for which the URL discovery component 318 is to receive lists of URLs for Web pages in the sites to be tested. With such a subscription in place, the URL discovery component 318 can regularly receive updated lists of Web pages for the specified sites. Also, the URL discovery component 318 can send the resulting URL discovery indicators 328 to the testing service 230.

In the testing service 230, a task triage component 330 can perform triage on the incoming inputs 320 (such as the API calls 322, the application indicators 324, the URL indicators 326, and the URL discovery indicators 328). For example, this triage can include prioritizing the inputs 320. This prioritizing can include applying priority rules to the inputs 320. For example, user input (such as user input through the API callers 312 or the online interface 316) may specify a priority for a set of one or more inputs 320. Also, for recurring continuous testing jobs that are automatically updated (such as automatically updated with inputs from the application discovery component 314 or the URL discovery component 318), such jobs may have priorities specified along with other specifications for the tests on a particular target (such as specifying which particular tests to conduct on a specified target site, a maximum number of testing tasks that can be performed on a particular online target site per unit time (e.g., no more than 300 requests per second), etc.). The triage component 330 can also perform other operations, such as performing de-duplication on the inputs 320. For example, if a test is currently being conducted on a specified endpoint 254 of a target 252, and an input 320 is received in the triage component 330, requesting the same test for the same endpoint 254, then the triage component 330 may delete that later-received input 320.

The task triage component 330 can insert the triaged testing tasks 332 in priority/affinity queues 334. For example, in one implementation, the priority/affinity queues 334 may include a high priority queue, a low priority queue, and a very high priority queue. Each task 332 can specify an endpoint to be tested, possibly a target to be tested (such as an application and/or an online target such as a Website), and possibly a specified test to run on the endpoint (though the test may be a default test without an explicit specification of the test in the task). Each task 332 may also include data specifying the type of task 332, such as the types of tests to be run (which can be defined in test definitions 338, which can be accessed by the work scheduler 340 and/or the test environments 350), the nature of the endpoint being tested (such as whether the endpoint is an online endpoint that is publicly available, an online endpoint that is not publicly available such as an endpoint on a private network, an application that is configured to be run within a specified framework (such as on a specified operating system), etc.). Such data indicating the type of task 332 may be used to allow a work scheduler 340 to assign the task to an appropriate test environment 350 with an affinity for con conducting a type of test requested by the task. For example, the work scheduler 340 may maintain affinities 342 for one or more test environments 350, which can be data indicating that particular test environments 350 are configured to advantageously conduct particular types of tests. Some affinities 342 may be default affinities, which may indicate that the corresponding test environment 350 is not to have an affinity for a particular type of task 332, but is equally available for use in running any of the task types.

In addition to assigning tasks 332 from the queues 334 to the test environments 350, the work scheduler 340 can monitor and manage the test environments 350. For example, the work scheduler 340 can activate test environments 350. For example, where the test environments 350 are virtual machines, the activation by the work scheduler 340 may involve the work scheduler 340 initiating a startup of a new virtual machine from an image. Such a newly-activated test environment 350 may include resources that can be activated within the test environment 350 to conduct tests specified by a variety of different types of tasks 332. Indeed, the testing service 230 may use the same image to activate all the test environments 350. Alternatively, the testing service may use a variety of different images for different types of test environments 350 to be activated.

The test environments 350 can operate in parallel so that different test environments 350 can be conducting different tests at the same time. Indeed a single test environment 350 may conduct multiple tests for multiple different tasks at the same time. Each test environment 350 can run at least one detector 352 within that test environment 350. Also, the test environment 350 may include multiple different detectors 352 that can each be run for conducting tests for different types of tasks 332. Each test environment 350 may also run components that can be configured to interact with the target(s) being tested. For example, each test environment 350 may have multiple emulators 354 installed to run target applications 356 within the emulators 354, as well as multiple Web browsers 358 to interact with online endpoints 254 being tested. Accordingly, each of the test environments 350 may have the same capabilities in some implementations. However, the work scheduler 340 may initiate the configuration of different test environments 350 to handle different types of tasks 332. For example, different configurations may include running different facilitating components, such as different detectors 352, emulators 354 and/or browsers 358. Such configurations may also include other types of configuration items, such as providing particular settings in the components of the test environment 350, entering appropriate credentials to interact with targets for specified types of tasks 332, and/or other types of configuration items.

FIG. 3 illustrates one test environment 350 running an emulator 354, which is running a target application 356 being tested within the emulator. For example, the emulator 354 may emulate a particular type of operating system interacting with the target application 356, such as a mobile operating system. Thus, the emulator 354 can translate inputs to and outputs from the target application 356 so that the target application 356 can operate as if it were running in the actual operating system. Also, a detector 352 can provide inputs to the emulator 354 and detect responses of the target application 356 to such inputs. For example, the detector 352 may feed strings into the emulator 354, which may mimic user input responses and/or may be in the form of API calls or other input. The emulator 354 can process such input and provide appropriate input to the target application 356. The target application 356 can provide responses to such input, which can be handled by the emulator 354 and detected by the detector 352.

FIG. 3 illustrates another test environment 350 running a browser 358. The browser 358 can be a standard Web browser that is configured to interact with online resources. For example, if a task 332 dictates providing a particular string to a specified URL as part of a test, then the work scheduler 340 can provide that string to the detector 352, which can feed the URL and the string into the browser 358. In response, the browser 358 can initiate contact with the endpoint associated with the URL, and can provide the specified string to an online endpoint for the URL. As an example, when testing for cross-site scripting vulnerabilities, one such string provided to an online endpoint may include the following: <script>alert(1);</script>. The detector 352 can monitor responses from the endpoint, to determine whether the responses exhibit behavior that indicates a type of vulnerability being tested. For example, the detector 352 may intercept communications to the browser 358 from the endpoint, or receive output from the browser 358 itself.

Many other configurations of test environments 350 are possible. For example, in performing a requested task 332, the test environment 350 may be running multiple different browsers 358, or one or more browsers 358 and one or more target applications 356, which may or may not be running inside of one or more emulators 354.

The work scheduler 340 can monitor the status of the queues 334. In one example, the work scheduler 340 can take tasks 332 from the very high priority queue first, and if the very high priority queue is empty, then from the high priority queue, and if the high priority queue is empty, then from the low priority queue. The work scheduler 340 can then feed the tasks 332 to available test environments 350, giving preference to the test environments 350 with affinities 342 that match the respective tasks 332. For example, if the next task 332 to be taken from the high priority queue (such as in a first-in-last-out order) is type A, and three test environments 350 are available to take the task 332, one with an affinity 342 for types B and E, another with default affinity, and another with affinity for type A, then the type A task can be assigned to the test environment 350 with an affinity for tasks of type A. If these same test environments 350 were available and a task of type D was the next task to be taken from the queues 334, then the type D task could be assigned to the test environment 350 with the default affinity. Thus, test environments 350 may be thought of as being split into different pools, with each pool including only test environments with a particular affinity 342 (such as a type A task affinity pool, a default affinity pool, etc.). The work scheduler 340 can take each task 332 from the queues 334 and assign that task 332 to a test environment 350 in the pool with an affinity for that type of task. If there are no available machines in a pool for that type of task, then the task can be assigned to the default pool.

Because a test environment 350 in the default pool may not be preconfigured to handle a particular type of task 332 assigned to it, that test environment 350 may be configured prior to running the particular test requested by the task 332. For example, this may include starting up an emulator or browser within the test environment 350, setting particular configuration items within the test environment, providing credentials for accessing resources that require such credentials, and other configuration acts. Also, if the work scheduler 340 determines (such as from health monitoring) that one pool is overloaded while another pool is underloaded, the work scheduler 340 can reconfigure one or more test environments and make corresponding changes to the affinities 342 of the reconfigured test environments 350. Thus, the work scheduler 340 can move one or more test environments 350 from one affinity pool to another. Additionally, a test environment 350 may have more than one affinity 342 and be included in more than one pool. For example, a particular test environment 350 may have an affinity for tasks of type A and B, and thus be part of affinity pools A and B.

If the work scheduler 340 determines that the overall set of test environments 350 is overloaded or underloaded, the work scheduler 340 can automatically scale the set of test environments 350 accordingly. For example, this determination may include the work scheduler 340 monitoring how many tasks 332 are in the priority queues 334. There may be a pre-defined operating range of counts of tasks 332. If the count of tasks in the queues 334 falls below this range, then the work scheduler 340 can deactivate one or more test environments 350. If the count of tasks in the queues 334 is higher than this range, then the work scheduler 340 can activate one or more additional test environments 350 and configure the test environment(s) 350 according to configuration specifications for one or more affinities 342. The determination of overloading and/or underloading of the test environments 350 can include one or more other factors in addition to or instead of the count of tasks in the queues 334. Such other factors may include results of monitoring resource usage by each of the test environments 350, performance of the test environments 350 (which may be degraded if the test environments 350 are overloaded), and/or other factors.

The work scheduler 340 can monitor loads and other health indicators of the test environments 350. In addition to using data from such monitoring for dynamic scaling of the test environments 350, as discussed above, the work scheduler 340 can use such information to direct new tasks 332 from the queues 334 to appropriate test environments 350 (load balancing for the test environments 350). Indeed, even if a task 332 is already assigned to a test environment 350, but the assigned test environment 350 is determined by the work scheduler to be unhealthy (e.g., if that test environment 350 stops responding to inquiries such as computer-readable heartbeat data communications from the work scheduler), then the work scheduler 340 can reassign that task to a different test environment 350.

The work scheduler 340 can also enforce limits that can protect online targets 252 being tested. For example, the work scheduler 340 may maintain time-based limits on tests that can be performed on particular online targets 252 by the overall vulnerability testing service 230. For example, the limits may indicate that only 300 requests per second can be sent to a specified Website. The work scheduler 340 can enforce such limits by limiting the number of requests sent by each of the test environments. For example, the work scheduler 340 can send computer-readable instructions to each test environment that is receiving tasks 332 for testing vulnerabilities of that Website, assigning each such test environment a sub-limit, so that all the sub-limits add up to no more than the total limit of 300 requests per second. As a simplified example, if ten test environments 350 are sending requests to the Website, then the work scheduler 340 can limit each of those test environments 350 to 30 requests per second to the Website. The work scheduler 340 can provide different limits to different test environments 350 (for example, one test environment 350 may have a limit of 30 requests per second to a particular target an another test environment 350 may have a limit of 10 requests per second to that same target). Also, the work scheduler 340 may enforce the limits in some other manner, such as by throttling the assignment of tasks 332 from the queues 334 to the test environments 350 to assure that the overall limit is not exceeded.

Each detector 352 can provide detector output 360 from the detected results of each of the vulnerability testing tasks 332. For example, the output 360 may indicate that endpoint A of Website Z exhibits a particular specified vulnerability, along with indicating specifics of the vulnerability. The output 360 can also indicate which vulnerabilities were tested but not detected. An output processor 370 can process the output 360. For example, if the detector output 360 indicates a particular vulnerability for a particular target, the output processor 370 can determine whether a bug job 372 should be automatically generated and assigned to a particular profile (such as a group profile or user profile) for addressing the bug (the vulnerability in this situation). For example, such a bug job 372 can be generated and included in a development service 260 for the corresponding target. The output processor 370 can also provide other output, such as summaries and details of the test results. Such results may be send in data communications, such as email 374, and/or a testing dashboard 376. Such a dashboard 376 may also include other capabilities, such as performing data analysis on the test results, and controls for requesting additional vulnerability testing by the testing service 230.

The architecture and components discussed above may be altered in various ways, such as by having test environments 350 that are physical machines rather than virtual machines, although the virtual machines and the other computer components discussed herein run on physical hardware, which may be configured according to computer software.

### III. Scalable Computer Vulnerability Testing Techniques

Several scalable computer vulnerability testing techniques will now be discussed. Each of these techniques can be performed in a computing environment. For example, each technique may be performed in a computer system that includes at least one processor and memory including instructions stored thereon that when executed by at least one processor cause at least one processor to perform the technique (memory stores instructions (e.g., object code), and when processor(s) execute(s) those instructions, processor(s) perform(s) the technique). Similarly, one or more computer-readable memory may have computer-executable instructions embodied thereon that, when executed by at least one processor, cause at least one processor to perform the technique. The techniques discussed below may be performed at least in part by hardware logic.

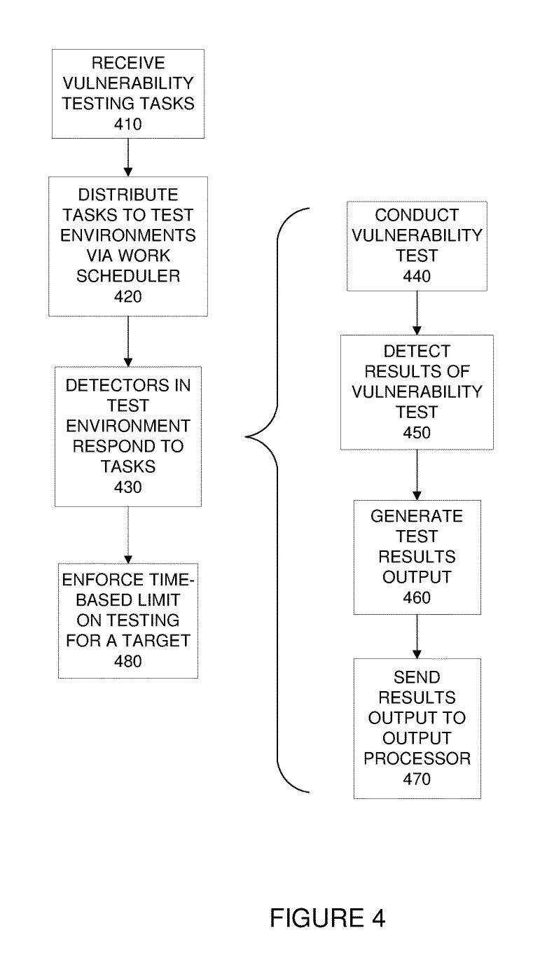

Referring to FIG. 4, a scalable computer vulnerability testing technique will be described. The testing can be “scalable”, which refers to the testing involving multiple tasks, targets, endpoints, and/or tests, wherein the system is designed to allow numbers of tasks, targets, endpoints, and/or tests to be varied. As discussed more herein, the technique may also include dynamic scaling, such as dynamic scaling that involves activating and/or deactivating computerized test environments in response to identifying overloaded or underloaded states for the available test environments. The technique can include receiving 410, via a work scheduler, a plurality of computer-readable computer vulnerability testing tasks identifying a plurality of targets to be tested and a plurality of tests (which may all be the same type of test or may include different types of tests) to be run on computerized targets specified in the tasks. Each of the tasks can identify an endpoint of a target and a test to be run on the target, and the work scheduler can be a computer component running on computer hardware, such as hardware including memory and a processor. Each of the targets can also be a computer component running on computer hardware, such as hardware including memory and a processor. The technique can also include distributing 420, via the work scheduler, the tasks to a plurality of test environments running on computer hardware. Each of the test environments can have a detector computing component running in the environment. Each detector component can respond 430 to receiving one of the tasks from the work scheduler. The response 430 of the detector can include conducting 440 a vulnerability test on an endpoint of a target, with the endpoint and the test being specified by the task. The response 430 can also include detecting 450 results of the vulnerability test, with the results indicating whether behavior of the target in response to the test indicates presence of a vulnerability corresponding to the vulnerability test. The response 430 can also include generating 460 output indicating the results of the vulnerability test, and may also include sending 470 the output to an output processor. Each of the following paragraphs discusses an addition feature for the technique of FIG. 4, and those features may be used alone or in any combination with each other.

Each of the test environments may be a virtual computing machine, such as where the virtual machine runs a detector component and one or more software components configured to facilitate testing that is conducted via the detector component.

The technique of FIG. 4 may include multiple different detector components in multiple different test environments conducting multiple vulnerability tests at the same time as each other, with the multiple vulnerability tests conducted at the same time as each other being specified in tasks received from the work scheduler.

The technique of FIG. 4 may further include the work scheduler enforcing 480 an overall time-based limit on testing for a target of the plurality of targets, with the time-based limit setting a maximum impact of testing that is managed by the work scheduler. For example, the time-based limit may specify a maximum number of requests that can be sent to the target per unit of time (such as a limit on number of requests per second). The technique of FIG. 4 may include conducting tests on a target to which the time-based limit applies through a plurality of the test environments during a time period. The enforcing 480 of the overall time-based limit for the target can include imposing, via the work scheduler, a time-based sub-limit on each of the plurality of test environments through which the tests are being conducted on the target to which the time-based limit applies.

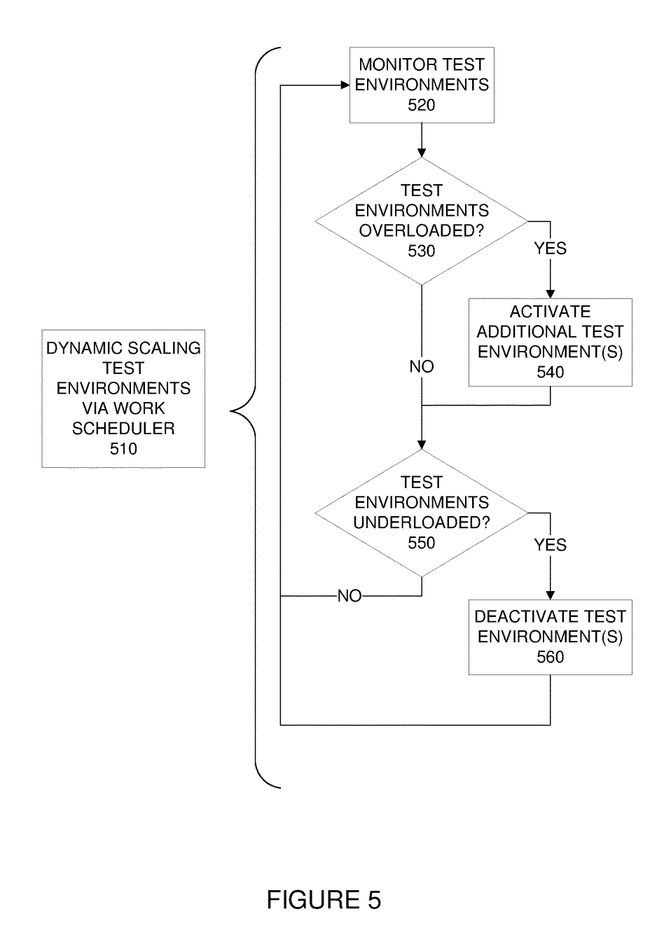

The test environments in the technique of FIG. 4 may be in a set of test environments. Further, with reference to FIG. 5, the technique of FIG. 4 may include dynamically scaling 510 the set of test environments via the work scheduler. The dynamic scaling 510 can include monitoring 520, via the work scheduler, the set of test environments. The dynamic scaling 510 can also include determining 530, via the work scheduler, whether the set of test environments is overloaded. If it is determined 530 that the set of test environments is overloaded, then the dynamic scaling 510 can include responding to the determining that the set of test environments is overloaded by activating 540 (which may be automatic), via the work scheduler, one or more additional test environments in the set of test environments so that the one or more additional test environments are then available to have vulnerability testing tasks assigned to those one or more additional test environments from the work scheduler.

Referring still to FIG. 5, the dynamic scaling 510 may further include determining 550 whether the set of test environments is underloaded. If so, then the dynamic scaling 510 can include responding to the determining 550 by de-activating (which may be automatic), via the work scheduler, one or more test environments from the set of test environments, so that the one or more de-activated test environments are no longer available for assigning vulnerability testing tasks from the work scheduler. The acts of the dynamic scaling 510 need not be conducted in the order illustrated in FIG. 5. Indeed, the monitoring 520, determining 530, activating 540, determining 550, and deactivating 560 may be combined with each other and/or conducted in parallel with each other.

The technique of FIG. 4 may include a first subset of the test environments being configured to conduct a first type of vulnerability test (where a type of vulnerability test may include a type of an endpoint being tested), and a second subset of the test environments being configured to conduct a second type of vulnerability test that is different from the first type of vulnerability test. The distributing 420 of tasks can include recording a first affinity of a first subset of test environments for the first type of vulnerability test and a second affinity of a second subset of test environments for the second type of vulnerability test, with an affinity being a data structure that indicates the affinity of the test environment for one or more different types of tests (which may include an affinity for one or more types of endpoints and/or targets being tested). The distributing 420 of the tasks can favor the first subset to receive tasks to perform the first type of vulnerability test, in response to the recording of the first affinity. The distributing 420 of tasks can favor the second subset to receive tasks to perform the second type of vulnerability test, in response to the recording of the second affinity.

The receiving 410 of the tasks can include receiving 410 the tasks from a plurality of different pipelines that discover targets to be tested and that discover endpoints to be tested within those targets. The technique of FIG. 4 may further include the different pipelines discovering the targets and the endpoints, and the different pipelines communicating inputs to the work scheduler, where the inputs can include identifications of the plurality of targets and the endpoints.

The technique of FIG. 4 may include assigning priorities to the tasks, and the distributing 420 of the tasks can be performed using the assigned priorities for the tasks.

The targets can include a target that is an online service identified by a domain (such as a domain on the Internet (e.g., testingtarget.com), or on a private network). The conducting 440 of a test on the online service can include running an online browser in one of the test environments, instructing the online browser to send a computer-readable string to the online service, and detecting a response of the online service to the string.

The targets in the technique of FIG. 4 may include a target that is an application. The conducting 440 of a test on the application can include the following: running an emulator application in a test environment of the plurality of test environments; running the target in the test environment via the emulator application; injecting input to the target via the emulator application; and detecting a response of the target to the input.

The targets in the FIG. 4 technique may include a plurality of testable applications available from an application store. The FIG. 4 technique may further include querying an online application store for computer applications meeting a specified criterion (possibly in combination with one or more other criteria); receiving a response from the application store indicating that the testable applications meet the specified criterion; and in response to the response from the application store, automatically generating tasks for conducting tests on the testable applications with the testable applications running in the test environments.

The targets of the technique of FIG. 4 may include a variety of different types of computerized targets, such as applications and online services. For example, applications may include mobile applications and/or bots.

A computer system can include means for performing one or more of the acts discussed above with reference to FIGS. 4-5 in different combinations with each other.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/we claim:

1. A computer system comprising:
at least one processor; and
memory comprising instructions stored thereon that when executed by at least one processor cause at least one processor to perform acts comprising:
receiving, via a work scheduler, a plurality of computer-readable computer vulnerability testing tasks identifying a plurality of targets to be tested and a plurality of tests to be run on targets specified in the tasks, with each of the vulnerability testing tasks identifying an endpoint of a target and a test to be run on the target, with the work scheduler being a computer component running on computer hardware, and with each of the targets being a computer component running on computer hardware;
distributing, via the work scheduler, the tasks to a plurality of test environments running on computer hardware, with each of the test environments being a virtual computing machine with a detector computing component running in the virtual machine;
each detector component performing the following in response to receiving one of the tasks from the work scheduler:
conducting a vulnerability test on an endpoint of a target, with the endpoint and the test being specified by the task;
detecting results of the vulnerability test, with the results indicating whether behavior of the target in response to the test indicates presence of a vulnerability corresponding to the vulnerability test;
generating output indicating the results of the vulnerability test; and
sending the output to an output processor.

2. The computer system of claim 1, wherein the acts comprise multiple different detector components in multiple different test environments conducting multiple vulnerability tests at the same time as each other, with the multiple vulnerability tests conducted at the same time as each other being specified in tasks received from the work scheduler.

3. The computer system of claim 1, wherein the test environments are in a set of test environments, and wherein the acts further comprising the following:
dynamically scaling the set of test environments via the work scheduler, with the dynamic scaling comprising the following:
monitoring, via the work scheduler, the set of test environments;
determining, via the work scheduler, that the set of test environments is overloaded; and
in response to the determining that the set of test environments is overloaded, automatically activating, via the work scheduler, one or more additional test environments in the set of test environments so that the one or more additional test environments are then available to have vulnerability testing tasks assigned to those one or more additional test environments from the work scheduler.

4. The computer system of claim 1, wherein the test environments are in a set of test environments, and wherein the acts further comprising the following:
dynamically scaling the set of test environments via the work scheduler, with the dynamic scaling comprising the following:
monitoring, via the work scheduler, the set of test environments;
determining, via the work scheduler, that the set of test environments is underloaded; and
in response to the determining that the set of test environments is underloaded, automatically de-activating, via the work scheduler, one or more test environments from the set of test environments, so that the one or more de-activated test environments are no longer available for assigning vulnerability testing tasks from the work scheduler.

5. The computer system of claim 1, wherein:
a first subset of the test environments is configured to conduct a first type of vulnerability test;
a second subset of the test environments is configured to conduct a second type of vulnerability test that is different from the first type of vulnerability test;
the distributing of the tasks comprises recording a first affinity of a first subset of test environments for the first type of vulnerability test and a second affinity of a second subset of test environments for the second type of vulnerability test;
the distributing of the tasks favors the first subset to receive tasks to perform the first type of vulnerability test, in response to the recording of the first affinity; and
the distributing of the tasks favors the second subset to receive tasks to perform the second type of vulnerability test, in response to the recording of the second affinity.

6. The computer system of claim 1, wherein the acts further comprise the work scheduler enforcing an overall time-based limit on testing for a target of the plurality of targets, with the time-based limit setting a maximum impact of testing that is managed by the work scheduler.

7. The computer system of claim 6, wherein the acts comprise conducting tests on a target to which the time-based limit applies through a plurality of the test environments during a time period, and wherein the enforcing of the overall time-based limit for the target comprises imposing, via the work scheduler, a time-based sub-limit on each of the plurality of test environments through which the tests are being conducted on the target to which the time-based limit applies.

8. The computer system of claim 1, wherein the receiving, via a work scheduler, a plurality of computer-readable computer vulnerability testing tasks comprises receiving the tasks from a plurality of different pipelines that discover targets to be tested and that discover endpoints to be tested within those targets, and wherein the acts further comprise:
the plurality of different pipelines discovering the plurality of targets and the endpoints; and
the plurality of different pipelines communicating identifications of the plurality of targets and the endpoints to the work scheduler.

9. The computer system of claim 1, the acts comprise assigning priorities to the tasks, and wherein the distributing of the tasks is performed using the assigned priorities for the tasks.

10. The computer system of claim 1, wherein the targets comprise a target that is an online service identified by a domain, and wherein the conducting of a test on the online service comprises:
running an online browser in one of the test environments;
instructing the online browser to send a computer-readable string to the online service; and
detecting a response of the online service to the string.

11. The computer system of claim 1, wherein the targets comprise a target that is an application, and wherein the conducting of a test on the application comprises:
running an emulator application in a test environment of the plurality of test environments;
running the target in the test environment via the emulator application;
injecting input to the target via the emulator application; and
detecting a response of the target to the input.

12. The computer system of claim 1, wherein the targets comprise a plurality of testable applications available from an application store, and wherein the acts further comprise:
querying an online application store for computer applications meeting a specified criterion;
receiving a response from the application store indicating that the testable applications meet the specified criterion; and
in response to the response from the application store, automatically generating tasks for conducting tests on the testable applications with the testable applications running in the test environments.

13. The computer system of claim 1, wherein the targets comprise a bot.

14. A computer-implemented method comprising the following acts:
receiving, via a work scheduler, a plurality of computer-readable computer vulnerability testing tasks identifying a plurality of targets to be tested and a plurality of tests to be run on targets specified in the tasks, with each of the vulnerability testing tasks identifying an endpoint of a target and a test to be run on the target, with the work scheduler being a computer component running on computer hardware, and with each of the targets being a computer component running on computer hardware;
distributing, via the work scheduler, the tasks to a set of test environments running on computer hardware, with each of the test environments in the set comprising a detector computing component;
each detector component performing the following in response to receiving one of the tasks from the work scheduler:
conducting a vulnerability test on an endpoint of a target, with the endpoint and the test being specified by the task;
detecting results of the vulnerability test, with the results indicating whether behavior of the target in response to the test indicates presence of a vulnerability corresponding to the vulnerability test;
generating output indicating the results of the vulnerability test; and
sending the output to an output processor;
dynamically scaling the set of test environments via the work scheduler, with the dynamic scaling comprising the following:
monitoring, via the work scheduler, the set of test environments;
determining, via the work scheduler, that the set of test environments is overloaded;
in response to the determining that the set of test environments is overloaded, automatically activating, via the work scheduler, one or more additional test environments in the set of test environments so that the one or more additional test environments are then available to have vulnerability testing tasks assigned to those one or more additional test environments from the work scheduler;
determining, via the work scheduler, that the set of test environments is underloaded; and
in response to the determining that the set of test environments is underloaded, automatically de-activating, via the work scheduler, one or more test environments from the set of test environments, so that the one or more de-activated test environments are no longer available for assigning vulnerability testing tasks from the work scheduler.

15. The method of claim 14, wherein:
a first subset of the set of test environments is configured to conduct a first type of vulnerability test;
a second subset of the set of test environments is configured to conduct a second type of vulnerability test that is different from the first type of vulnerability test;
the distributing of the tasks comprises recording a first affinity of a first subset of test environments for the first type of vulnerability test and a second affinity of a second subset of test environments for the second type of vulnerability test;
the distributing of the tasks favors the first subset to receive tasks to perform the first type of vulnerability test, in response to the recording of the first affinity; and
the distributing of the tasks favors the second subset to receive tasks to perform the second type of vulnerability test, in response to the recording of the second affinity.

16. The method of claim 14, wherein the acts further comprise the work scheduler enforcing an overall time-based limit on testing for a target, the time-based limit setting a maximum impact of testing that is managed by the work scheduler.

17. The method of claim 14, wherein the receiving, via a work scheduler, a plurality of computer-readable computer vulnerability testing tasks comprises receiving the tasks from a plurality of different pipelines that discover targets to be tested and that discover endpoints to be tested within those targets, and wherein the acts further comprise:
the plurality of different pipelines discovering the plurality of targets and the endpoints; and
the plurality of different pipelines communicating identifications of the plurality of targets and the endpoints to the work scheduler.

18. The method of claim 14, wherein the targets comprise a target that is an application, and wherein the conducting of a test on the application comprises:
running an emulator application in a test environment of the set of test environments;
running the target in the test environment via the emulator application;
injecting input to the target via the emulator application; and
detecting a response of the target to the input.

19. The method of claim 14, wherein the targets comprise a plurality of testable applications available from an application store, and wherein the acts further comprise:
querying an online application store for computer applications meeting a specified criteria;
receiving a response from the application store indicating that the testable applications meet the specified criteria; and
in response to the response from the application store, automatically generating tasks for conducting tests on the testable applications with the testable applications running in the test environments.

20. One or more computer-readable memory having computer-executable instructions embodied thereon that, when executed by at least one processor, cause at least one processor to perform acts comprising:
receiving, via a work scheduler, a plurality of computer-readable computer vulnerability testing tasks identifying a plurality of targets to be tested and a plurality of tests to be run on targets specified in the tasks, with each of the vulnerability testing tasks identifying an endpoint of a target and a test to be run on the target, with the work scheduler being a computer component running on computer hardware, and with each of the targets being a computer component running on computer hardware;
distributing, via the work scheduler, the tasks to a set of test environments running on computer hardware, with each of the test environments in the set comprising a detector computing component;
each detector component performing the following in response to receiving one of the tasks from the work scheduler:
conducting a vulnerability test on an endpoint of a target, with the endpoint and the test being specified by the task;
detecting results of the vulnerability test, with the results indicating whether behavior of the target in response to the test indicates presence of a vulnerability corresponding to the vulnerability test;
generating output indicating the results of the vulnerability test; and
sending the output to an output processor; and
enforcing, via the work scheduler, an overall time-based limit on testing for a target, the time-based limit setting a maximum impact of testing that is managed by the work scheduler, the enforcing of the overall time-based limit for the target comprises imposing, via the work scheduler, a time-based limit on each of the set of test environments through which the tests are being conducted on the target to which the time-based limit applies.
